(19) United States
(12) Patent Application Publication
(10) Pub. No.: US 2006/0066761 A1
(43) Pub. Date: Mar. 30, 2006

(54) Rear projection television

(75) Inventors: Koichi Tajima, Takefu-city (JP); Kenji Shimoshita, Takefu-city (JP); Takashi Tokuda, Takefu-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Takefu-city (JP)

(21) Appl. No.: 11/234,148

(22) Filed: Sep. 26, 2005

(30) Foreign Application Priority Data
Sep. 30, 2004 (JP) 2004-286455

(51) Int. Cl. H04N 5/74

(52) U.S. Cl. 348/748

(57) ABSTRACT

The present invention provides an inexpensive rear projection television including a cooling structure that blows air directly against a heating element that generates heat to become hot, thus suppressing a rise in the temperature of the heating element. In addition, the shapes of having exhaust ducts are simplified, thus reducing the cost. A first duct 71 and a second duct 101 are formed to have generally U-shaped cross sections; air blown by a first blowing fan 70 is exhausted to the exterior through the first duct 71 and external air is supplied to a second blowing fan 100 through the second duct 101. The U-shaped opening sides of the ducts are attached to a lower cabinet 5 to form cylindrical paths. Consequently, the costs of the ducts are lower than those of integrally cylindrically molded ducts.

The present application is based on and claims priority of Japanese patent application No. 2004-286455 filed on Sep. 30, 2004, the entire contents of which are hereby incorporated by reference.

### BACKGROUND OF THE INVENTION

1. Field of the Invention

The present invention relates to a rear projection television that reflectively projects an optical image projected by a projection unit on a screen exposed from a side surface of a housing.

2. Description of the Related Art

Japanese Patent Laid-Open Publication No. 2002-199307 (Patent Document 1) proposes a rear projection television having a through-hole formed in a cabinet and through which heat generated by an electronic circuit is released; the electronic circuit is a heating element provided in the cabinet.

Japanese Patent Laid-Open Publication No. 11-41547 (Patent Document 2) discloses a structure in which a projection device main body including a light source lamp, a heating element, by using a fan to eject air heated by the light source lamp section, through a cylindrical duct to circularly cool air in a case.

Japanese Patent Laid-Open Publication No. 11-103435 (Patent Document 3) proposes a structure in which an air duct is installed through which an air flow supplied to the interior of an optical engine unit by a cooling fan is partly taken in to blow air against a surface of a projection lens.

However, in the patent document 1, the through-hole is formed in the cabinet so that heated air rises and exits through the through-hole rather than being forcibly exhausted. A heating element generating a relatively small quantity of heat, such as an electronic circuit, can some what efficiently exhaust the heated air efficiently. However, in efficiently releasing heat from a heating element that becomes hotter than electronic parts or the like, the patent document 1 fails to achieve a better cooling efficiency than, for example, a fan that forcibly exhausts air.

Patent document 2 and 3 propose the apparatuses each containing the fan that forcibly cools heated air via the duct. However, since both apparatuses are provided with the cylindrical duct, when the duct is molded using resin or the like by a die, an ejection machine cannot smoothly release a molding from the die because of the integrally cylindrical shape of the duct. Consequently, these apparatuses have poor productivity, thus increasing manufacturing costs.

### SUMMARY OF THE INVENTION

The present invention is conceived in view of the above problems. It is an object of the present invention to provide an inexpensive rear projection television comprising a cooling structure blowing air against a heating element that generates heat to become hot, thus suppressing a rise in the temperature of the heating element. It is another object of the present invention to provide an inexpensive rear projection television in which the shapes of exhaust ducts are simplified to reduce the cost and weight of a molding material for the ducts.

According to a first aspect of the present invention, there is provided a rear projection television comprising a housing accommodating a lamp unit that generates heat during projection and a projection unit that modulates a beam projected by the lamp unit in accordance with image information to form an optical image, the projection unit generating heat when the optical image is projected in an enlarged form, wherein a first blowing fan is integrally provided on the lamp unit, and a second blowing fan is integrally provided on the projection unit, and in that the housing is provided with a first blowing fan that blows air directly against the lamp in the lamp unit and a second blowing fan that blows air directly against a heating element in the projection unit.

In the configuration according to first aspect, the first blowing fan is integrally provided on the lamp unit. Accordingly, the heated lamp can be exposed directly to air blown out as the first blowing fan is driven. Further, the second blowing fan is integrally provided on the projection unit. Accordingly, the heated heating element can be exposed directly to air blown out as the second blowing fan is driven. This enables the heated lamp and heating element to be directly cooled to suppress an increase in the temperature of the air in the housing.

A second aspect of the present invention is the rear projection television according to the first aspect, wherein a first duct through which air blown by the first blowing fan is exhausted to an exterior of the housing and a second duct through which external air is supplied to the second blowing fan are formed to have U-shaped cross sections and are each formed into a cylinder by attaching a U-shaped opening side to the housing.

In the configuration according to the second aspect, the first and second ducts are formed to have the U-shaped cross sections. Thus, during molding, the ducts can be released from die more easily than cylindrical ducts having generally rectangular cross sections. Further, compared to integrally cylindrically molded ducts, the ducts in accordance with the present invention enable a reduction in the amount of molding material such as resin which is required for molding. This makes it possible to reduce the weight of the ducts and thus the costs of the rear projection television.

A third aspect of the present invention is the rear projection television according to the second aspect, wherein an exhaust hole through which air from the first duct is exhausted to the exterior is formed in a rear surface of the housing, and an intake port through which external air is supplied to the second duct is formed in the rear surface of the housing, and wherein an intake hole through which external air is taken in is formed in a front surface of the housing which is opposite the rear surface.

With the configuration according to the third aspect, the housing is provided not only with the intake port through which external air is supplied to the interior of the housing but also with the intake hole through which external air is taken in. This enables external air to be smoothly supplied to the interior of the housing to suppress an increase in the temperature in the housing.

### BRIEF DESCRIPTION OF THE DRAWINGS

FIG. 1 is a top sectional view schematically showing the configuration of a rear projection television according an embodiment of the present invention as viewed from above;

FIG. 2 is a schematic sectional view mainly showing a lamp housing section in the rear projection television according an embodiment of the present invention;

FIG. 3 is an enlarged view showing the vicinity of a lamp unit in the rear projection television according an embodiment of the present invention;

FIG. 4 is a perspective view showing a first duct in the rear projection television according an embodiment of the present invention;

FIG. 5 is a schematic sectional view mainly showing a lamp unit in the rear projection television according an embodiment of the present invention;

FIG. 6 is an enlarged view showing the vicinity of a heating element in the rear projection television according an embodiment of the present invention; and

FIG. 7 is a perspective view showing a second duct in the rear projection television according an embodiment of the present invention.

### DETAILED DESCRIPTION OF THE PREFERRED EMBODIMENTS

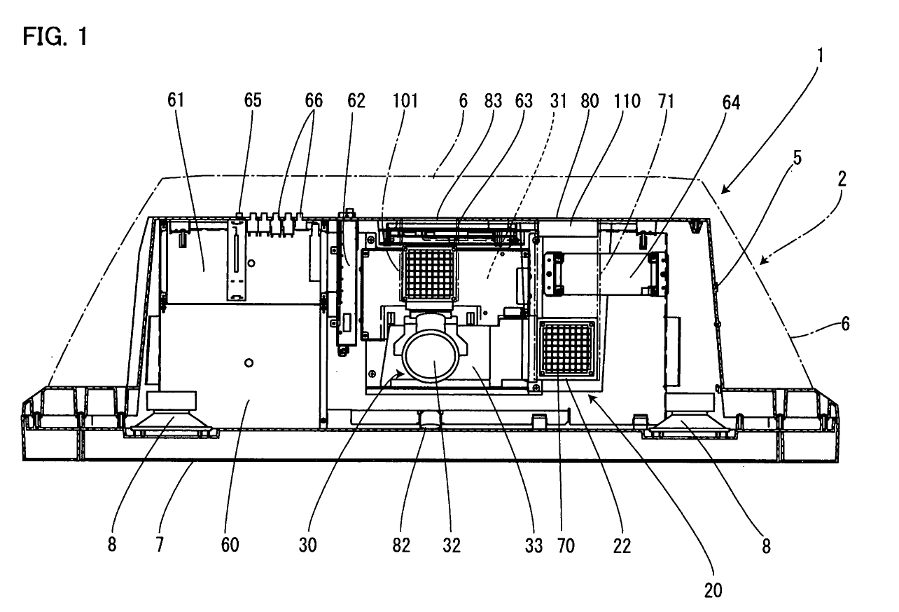

With reference to FIGS. 1 to 7, description will be given of an embodiment that is the best mode for carrying out the present invention. Of course, it is needless to say that the present invention can also be easily applied to configurations different from those described in the embodiment without departing from the spirit of the present invention.

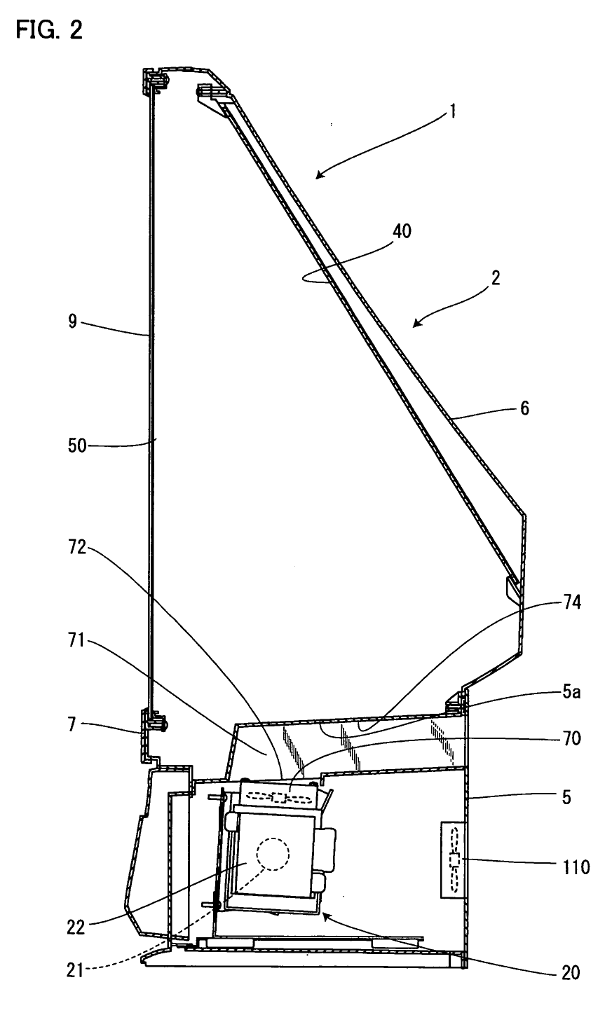

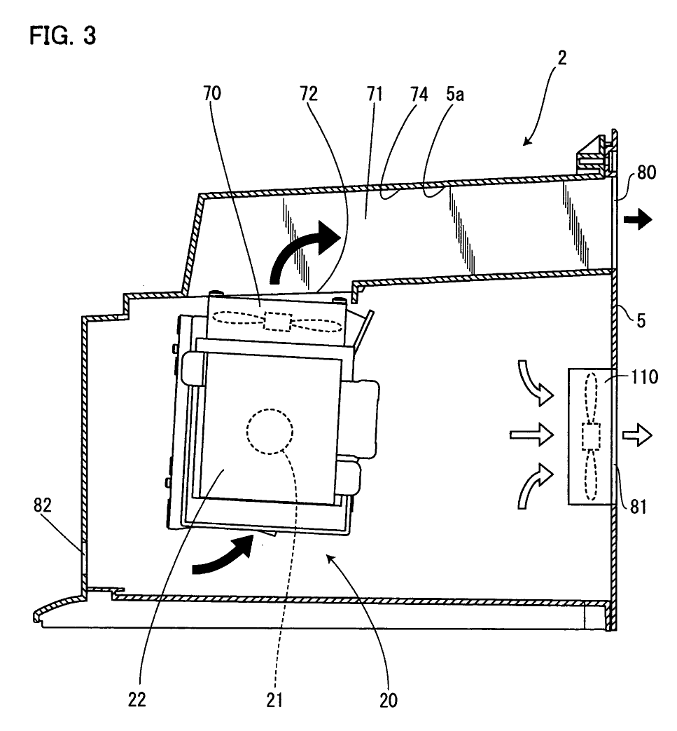

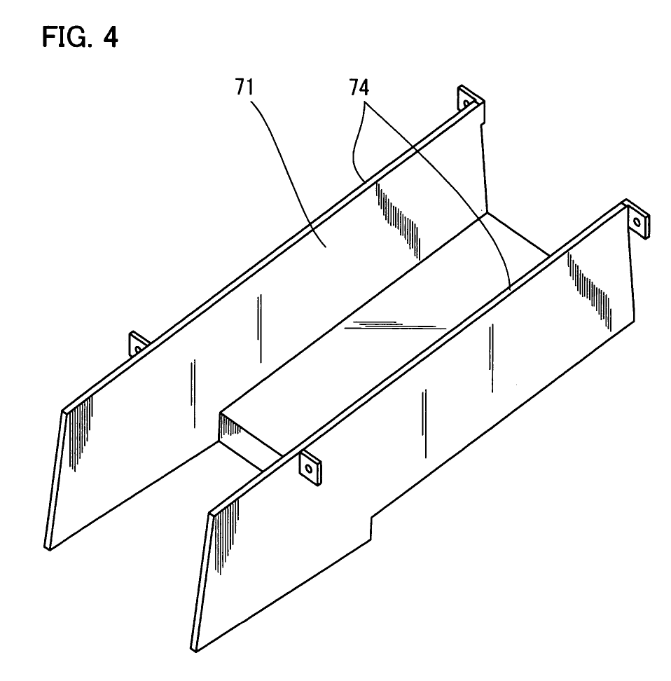

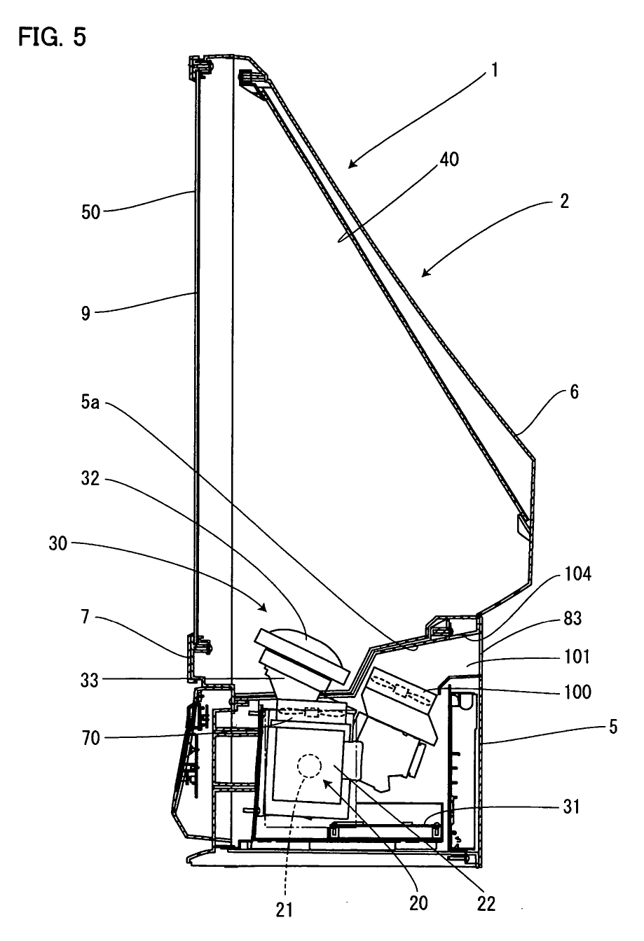

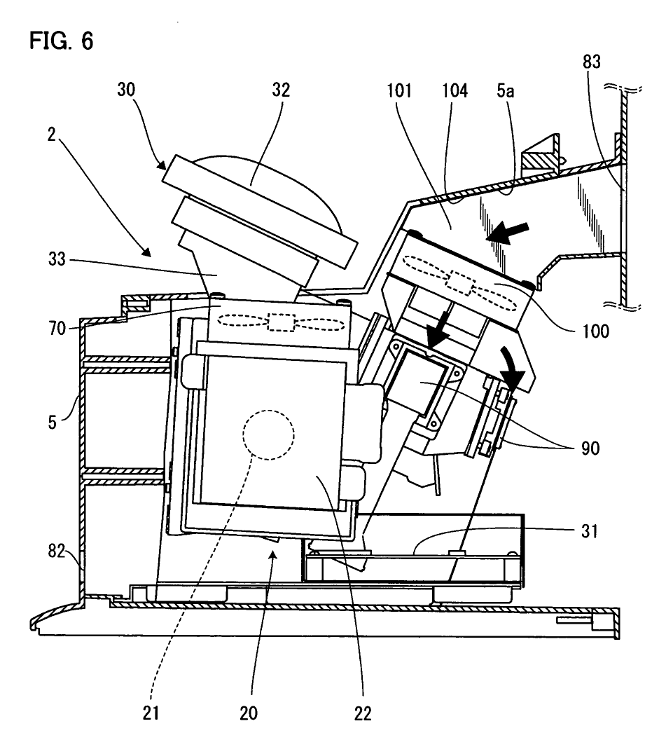

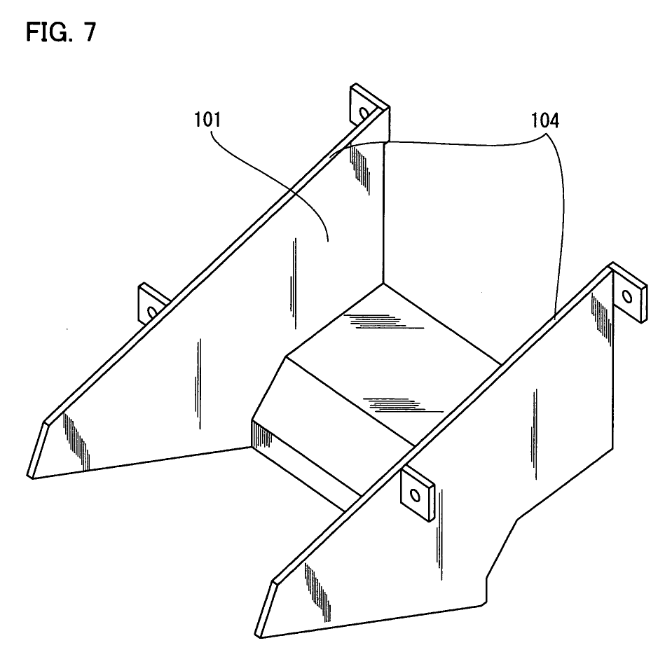

FIG. 1 is a top sectional view schematically showing the configuration of a rear projection television according an embodiment of the present invention as viewed from above. FIG. 2 is a schematic sectional view mainly showing a lamp housing section in the rear projection television. FIG. 3 is an enlarged view showing the vicinity of a lamp unit. FIG. 4 is a perspective view showing a first duct. FIG. 5 is a schematic sectional view mainly showing a lamp unit. FIG. 6 is an enlarged view showing the vicinity of a heating element. FIG. 7 is a perspective view showing a second duct.

With reference to these figures, description will be given of the main part of configuration of a rear projection television 1. The rear projection television 1 modulates a beam emitted by a light source in accordance with image information to form an optical image and then projects it on a screen in an enlarged form. The rear projection television 1 is mainly composed of a cabinet 2 constituting a housing, a lamp unit 20 placed in the cabinet 2 to generate head during projection, a projection unit 30 placed in the cabinet 2 to modulate a beam projected by the lamp unit 20 to form an optical image and to generate heat when the optical image is projected in an enlarged form, a reflection mirror 40 that reflects the optical image projected by the projection unit 30, and a screen 50 that projects an optical image from the reflection mirror 40.

The cabinet 2 is composed of a lower cabinet 5, and a back cabinet 6 and a front cabinet 7 fixed to the top of the lower cabinet 5. The lamp unit 20 and the projection unit 30 are fixed in the lower cabinet 5 using screws (not shown) A lateral pair of speakers 8 is fixed to a front surface of the lower cabinet 5. Further, the reflection mirror 40 is fixed to the back cabinet 6. The screen 50 is fixed opposite the reflection mirror 40 and in a display window 9 formed at a front surface of the front cabinet 7.

Now, the lamp unit 20 will be described in detail. The lamp unit 20 comprises a lamp 21 as a light source; the lamp 21 may be a halogen lamp, a metal halide lamp, or the like, that is, a heating element to which a high voltage is applied to generate heat at a temperature of 60 to 90° C. A first blowing fan 70 is integrally provide at the top of the lamp unit 20 to blow the air in the lower cabinet 5 upward and exhaust it to the exterior of the lower cabinet 5 (as shown by a black arrow in FIG. 3). The lamp 21 is accommodated in a lamp housing section 22 shaped like a cylinder extending in a vertical direction. The lamp 21 can be detachably accommodated in the lamp housing section 22. The first blowing fan 70 is driven to take in air from the bottom of the lamp housing section 22 and blows it against the lamp 21, which generates heat during projection, thus suppressing an increase in temperature and releasing the heat generated by the lamp 21. The first blowing fan 70 exhausts the air to the exterior of the lower cabinet 2 from an exhaust hole 80 formed in a rear surface of the lower cabinet 5, via a cylindrical path consisting of a first duct 71 and a planar inner top surface 5a of the lower cabinet 5. A third blowing fan 110 is driven to exhaust the air in the lower cabinet 5 from an open hole 81 in the lower cabinet 5; the third blowing fan 110 is fixed to a rear surface of the lower cabinet 5 and located below the first blowing fan 70. The first dust 71 is formed to have a generally U-shaped cross section. The path through which air is exhausted is formed to be a cylinder with a generally rectangular cross section by using screws to fixedly attach the opening side (the upper part of the first duct 71 shown in FIG. 4) of the U-shaped first duct 71 to the planar inner top surface 5a of the lower cabinet 5, serving as a housing. Thus, when the first blowing fan 70 is driven, air from a blowing opening 72 is supplied to the first duct 71.

Now, the projection unit 30 will be described. The projection unit 30 optically processes a beam emitted by the lamp unit 20, a light source, to form an optical image and then project it in an enlarged form. The projection unit 30 comprises, for example, a driver circuit substrate 31 that drives the projection unit 30, a projection lens 32, and a plurality of heating elements 90 that generate heat at a temperature of 40 to 90° C. A second blowing fan 100 is provided above the plurality of heating elements 90 integrally with the projection unit 30 so that the heating elements 90 can be exposed directly to air. The second blowing fan 100 is driven to blow air directly against the plurality of heating elements 90, which generate heat while the rear projection television 1 is driven. This makes it possible to suppress an increase in the temperature of heating elements 90. With the path through which external air is supplied to the second blowing fan 100, external air can be supplied to the interior of the lower cabinet 5 through an intake port 83 formed in the rear surface of the lower cabinet 5, via a cylindrical path consisting of a second duct 101 and the planar inner top surface 5a of the lower cabinet 5. That is, like the first duct 71, the second duct 101 is formed to have a generally U-shaped cross-section. The path through which air is supplied to the lower cabinet 5 is formed to have a generally rectangular cross section by using screws to fixedly attach the opening side (the upper side of the second duct 101 shown in FIG. 7) of the U-shaped second duct 101 to the planar inner top surface 5a of the lower cabinet 5. More specifically, the cylinder consisting of the inner top surface 5a and the first duct 71 is formed by abutting a linear upper edge 74 of the first duct 71 against the planar inner top surface 5a of the lower cabinet 5. The cylinder consisting of the inner top surface 5a and the second duct 101 is formed by abutting a linear upper edge 104 of the second duct 101 against the planar inner top surface 5a of the lower cabinet 5.

A projection lens 32 is fixed to a casing 33 of the projection unit 30. Although not shown, the casing 33 contains, for example, a relay lens that makes beams from the lamp 21 substantially parallel, a polarization beam splitter that divides the beam transmitted through the relay lens into a transmission beam and a reflection beam, and a polarization conversion element consisting of a reflective liquid crystal panel that modulates the beam reflected or transmitted by the polarization beam splitter to obtain a video beam. These components are integrally fixed together into a unit. The video beam modulated by the polarization conversion element is projected on the reflection mirror 40 by the projection lens 32, incorporated in a top surface of the casing 33.

Further, a power supply circuit board 60 and an analog signal processing substrate 61 are arranged in the front and rear, respectively, of the projection unit 30 (in FIG. 1, in the vertical direction). A digital circuit board 62 is placed between both power supply board 60 and analog signal processing board 61 and the projection unit 30. Furthermore, a scaler circuit board 63 is placed on a rear surface of the projection unit 30. In the lamp unit 20, a lamp driving circuit board 64 is placed on a rear surface of the lower cabinet 5.

Moreover, the power supply circuit board 60 supplies power to the lamp driving circuit board 64 and a signal and control microcomputer (not shown). An analog tuner 65 and an I/O terminal 66 are mounted on the analog signal processing substrate 61. An analog signal input through the analog tuner 65 is output to an external apparatus through the I/O terminal 66. An analog signal input through the I/O terminal 66 is output to the scaler circuit board 63. Further, the analog signal processing substrate 61 comprises an audio block that generates a sound multiplex signal and a surround signal, to process analog signals such as sound signals. The digital circuit board 62 comprises a digital tuner, a digital tuner input circuit, and a D/A converter (not shown) that converts a digital signal into an analog signal. The digital circuit board 62 sends a digital signal to the analog signal processing substrate 61 and scaler circuit substrate 63. The scaler circuit board 63 converts the digital signal into a predetermined display form (resolution) on the basis of a signal sent by the analog signal processing circuit 61. The scaler circuit board 63 mainly executes a process required to display signals on a screen 50. Furthermore, the scaler circuit board 63 comprises a video decoder circuit (not shown) and has a function for decoding a compressed input signal. The lamp driving circuit board 64 is used to control the lamp 21 and comprises a transformer that generates and outputs a high voltage (about 1,000 V) required to light the lamp 21, to the driver circuit board 31. The driver circuit board 31 is used to control the projection unit 30; the driver circuit board 31 controls turn-on and -off of the lamp 21 and the white balance and brightness of the display screen on the basis of the voltage output by the lamp driving circuit substrate 64.

As described above, in the present embodiment, the first blowing fan 70 is integrally provided on the lamp unit 20 using screws. The second blowing fan 100 is integrally provided on the projection unit 30 using screws. The lower cabinet 5 contains the first blowing fan 70, which blows air directly against the lamp 21 of the lamp unit 20, and the second blowing fan 100, which blows air directly against the heating elements 90 of the projection unit 30. Consequently, the heated lamp 21 can be exposed directly to air blown out as the first blowing fan 70 is driven. The heated heating elements 90 are exposed directly to air blown out as the second blowing fan 100 is driven. Thus, in contrast to the conventional rear projection television, which exhausts hot air from the cabinet on the basis of natural exhaust without using any blowing fans to lower the temperature of interior of the housing, the present embodiment blows air directly against the lamp 21 and heating elements 90, which generate heat, to directly cool them. This makes it possible to suppress an increase in the temperature of the air in the lower cabinet 5, which serves as a housing. It is thus possible to prevent heat from affecting various electronic parts such as a resistor and an electrolytic capacitor. That is, the first and second blowing fans 70 and 100 are integrated with the lamp unit 20 and projection unit 30; the first and second blowing fans 70 and 100 blow air against the lamp 21 and heating elements 90, which generate large quantities of heat. This enables the interior of the lower cabinet 5 to be appropriately cooled more efficiently. Further, by suppressing an increase in the temperatures of the lamp 21 and heating elements 90, it is possible to provide an excellent rear projection television 1 that can avoid a decrease in the life expectancies of various parts in the lower cabinet 5 or even failures.

Further, the first duct 71 through which air is exhausted to the exterior of the lower cabinet 5 and the second duct 101 are formed to have generally U-shaped cross sections; air is exhausted to the exterior of the lower cabinet 5 through the first duct 71 and external air is supplied through the second duct 101. Accordingly, compared to, for example, a cylindrical duct with a generally rectangular cross section which is blocked in all directions, the present dusts can be easily released from dies after molding. Furthermore, compared to an integrally cylindrically molded duct, the present ducts make it possible to reduce the amount of molding material such as resin which is required for molding. Therefore, the weight of the duct can be reduced, thus providing a rear projection television 1 requiring only low costs.

Further, the exhaust hole 80 is formed in the rear surface of the lower cabinet 5 to exhaust air to the exterior of the cabinet 2. The intake port 83 is formed in the rear surface of the lower cabinet 5 to supply external air to the second duct 101. The intake hole 82 is formed in the front surface of the lower cabinet 5, which is opposite the rear surface. Consequently, the lower cabinet 5 has not only the intake port 83, through which external air is supplied, but also the intake hole 82, through which external air is introduced into the lower cabinet 5. This improves the efficiency with which external air is taken in, and allows external air to be smoothly supplied to the interior of the lower cabinet 5. It is thus possible to further suppress a rise in the temperature in the lower cabinet 5. Moreover, by attaching a blowing fan to the intake hole 82 which is used to supply air to the interior of the projection unit 30, it is possible to further suppress a rise in the temperature in the lower cabinet 5.

The embodiment of the present invention has been described above in detail. However, the present invention is not limited to the above embodiment. Many variations may be made to the embodiment without departing from the spirit of the present invention. For example, the shapes and mounting structures of the components in the cabinet are not limited to those described in the embodiment but may be appropriately selected. Further, in an example of the embodiment, the airflow in the lower cabinet is shown. However, the present invention is not particularly limited to the lower cabinet. Appropriate selection may be made on the basis of the shape. Furthermore, the shapes of the holes including the exhaust hole 80, open hole 81, intake hole 82, and intake port 83 may be appropriately selected. For example, a cover in which fine holes or the like are formed may be attached to each of the hole portions to prevent entry of contaminants such as external dust.

The first aspect of the present invention provides the rear projection television comprising a housing accommodating the lamp unit that generates heat during projection and the projection unit that modulates a beam projected by the lamp unit in accordance with image information to form an optical image, the projection unit generating heat when the optical image is projected in an enlarged form, wherein the first blowing fan is integrally provided on the lamp unit, and the second blowing fan is integrally provided on the projection unit, and wherein the housing is provided with the first blowing fan that blows air directly against the lamp in the lamp unit and the second blowing fan that blows air directly against the heating element in the projection unit. Consequently, air is blown directly against the lamp and heating element which generate large quantities of heat. This makes it possible to appropriately cool the interior of the housing and to suppress an increase in the temperatures of the lamp and heating element. It is thus possible to prevent the life expectancies of various parts in the housing from being shortened by heat resulting from a rise in the temperature of the air in the housing.

According to the second aspect, in the first aspect, the first duct through which air blown by the first blowing fan is exhausted to the exterior of the housing and the second duct through which external air is supplied to the second blowing fan are formed to have U-shaped cross sections and are each formed into a cylinder by attaching the opening side of the U shape to the housing. When formed to have U-shaped cross sections, for example, the ducts can be easily molded and released from dies during molding. This makes it possible to reduce the amount of molding material such as resin which is required for molding. Therefore, the weight and thus the cost of the ducts can be reduced, thus providing an inexpensive rear projection television.

According to the third aspect, in the second aspect, the exhaust hole through which air from the first duct is exhausted to the exterior is formed in the rear surface of the housing, and the intake port through which external air is supplied to the second duct is formed in the rear surface of the housing, and the intake hole through which external air is taken in is formed in the front surface of the housing which is opposite the rear surface. This makes it possible to further suppress an increase in the temperature of interior of the housing.

What is claimed is:

1. A rear projection television comprising a housing accommodating a lamp unit that generates heat during projection and a projection unit that modulates a beam projected by the lamp unit in accordance with image information to form an optical image, the projection unit generating heat when the optical image is projected in an enlarged form, wherein a first blowing fan is integrally provided on the lamp unit, and a second blowing fan is integrally provided on the projection unit, and wherein the housing is provided with a first blowing fan that blows air directly against the lamp in the lamp unit and a second blowing fan that blows air directly against a heating element in the projection unit.

2. The rear projection television according to claim 1, wherein a first duct through which air blown by the first blowing fan is exhausted to an exterior of the housing and a second duct through which external air is supplied to the second blowing fan are formed to have U-shaped cross sections and are each formed into a cylinder by attaching a U-shaped opening side to the housing.

3. The rear projection television according to claim 2, wherein an exhaust hole through which air from the first duct is exhausted to the exterior is formed in a rear surface of the housing, and an intake port through which external air is supplied to the second duct is formed in the rear surface of the housing, and wherein an intake hole through which external air is taken in is formed in a front surface of the housing which is opposite the rear surface.
